(19) United States
(12) Patent Application Publication
(10) Pub. No.: US 2017/0175843 A1
(43) Pub. Date: Jun. 22, 2017

(54) Piston And Cylinder Unit With An Add-On Part

(71) Applicant: ZF FRIEDRICHSHAFEN AG, Friedrichshafen (DE)

(72) Inventors: Harmut RÖLLEKE, Kircheib (DE); Dirk BECKER, Willroth (DE); Wolfgang HERTZ, Sankt Augustin (DE); Klaus SCHREINER, Windeck (DE)

(21) Appl. No.: 15/117,091

(22) PCT Filed: Jan. 8, 2015
(86) PCT No.: PCT/EP2015/050204

§ 371 Date: Aug. 5, 2016

(30) Foreign Application Priority Data
Feb. 6, 2014 (DE) 102014202205.3

(51) Int. Cl. F16F 9/54; F16F 9/32

(52) U.S. Cl. CPC F16F 9/54; F16F 9/3235; F16F 9/32; B21D 39/04

(57) ABSTRACT

A piston-cylinder unit having a cylinder with an add-on part which has a fastening portion that contacts a contact surface of the cylinder. A positive engagement connection fixing the add-on part to the cylinder is provided between the add-on part and the cylinder. The positive engagement connection is formed by a deformable rivet that extends through the fastening portion in a final assembly position and forms an undercut with the cylinder.

### CROSS REFERENCE TO RELATED APPLICATIONS

This is a U.S. national stage of application No. PCT/EP2015/050204, filed on Jan. 8, 2015. Priority is claimed on German Application No. DE102014202205.3, filed Feb. 6, 2014, the content of which is incorporated here by reference.

### BACKGROUND OF THE INVENTION

1. Field of the Invention

The invention is directed to a piston-cylinder unit and a production method with an add-on part.

2. Description of the Prior Art

A piston-cylinder unit constructed in the form of a vibration damper in which an add-on part is fixed by a radial positive engagement between the add-on part and the cylinder is known from DE 31 05 170 A1 or U.S. Pat. No. 7,810,620 B2. The add-on part is moved into the predetermined assembly position at the cylinder and the positive engagement is generated with a punching die.

In U.S. Pat. No. 7,810,620, the cylinder has at least one groove that receives the volume of the add-on part displaced by the die. A plurality of positive engagement connections are used in circumferential direction, and the add-on part has a fastening sleeve that encloses the cylinder over an area of more than 180°. Subsequently, after the positive engagement the add-on part can be displaced neither axially nor radially relative to the cylinder.

In DE 31 05 170 A1, the punching volume displaced by the die is deformed together with a wall region of the cylinder. Funnel-shaped punched edges are formed in the cylinder contingent upon the shape of the die. An undercut that allows an add-on part with a contact region of less than 180° with respect to the cylinder is not possible with this type of positive engagement connection.

Extensive trials have shown that the positive engagement connections known from the prior art withstand only a limited load.

### SUMMARY OF THE INVENTION

It is an object of the present invention to find a positive engagement connection between a piston-cylinder unit and an add-on part that has a higher load limit.

According to one aspect of the invention, this object is met in that the positive engagement connection is formed by a deformable rivet that extends through the fastening portion in a final assembly position and forms an undercut with the cylinder.

A great advantage of the invention is that not only can add-on parts with a sleeve-shaped fastening portion be used, but also add-on parts that extend only along a partial circumference of the cylinder without the add-on parts being able to be decreased radially. The undercut appreciably increases the axial retaining forces so that large retaining forces can be realized with a relatively small surface area requirement.

In a further advantageous configuration, the rivet has a rivet head supported on the fastening portion of the add-on part. The rivet head seals the positive engagement connection against moisture so that practically no corrosion can occur. Apart from this, surface-coated cylinders and add-on parts can also be used.

In one embodiment, the rivet has a radial widening at the end opposite the rivet head in the final assembly state. This results in a two-part undercut, with respect to the fastening portion and with respect to the cylinder.

It is further provided that the cylinder has a closed wall in the region of the riveting. Accordingly, cylinders with an operating medium can also be provided with an add-on part without having to adopt special sealing measures.

A rivet shaft of the rivet extends through a clearance cut in the add-on part in the final assembly state. Accordingly, the displaced volume in the region of the wall of the cylinder is permanently preloaded radially outward so that no relaxation phenomena can occur.

It has proven advantageous when the undercut has a diameter that substantially corresponds to the diameter of the rivet head.

A method for the production of a piston-cylinder unit comprising a cylinder with an add-on part that is intended to meet the above-stated object has the following working steps:
fixing the cylinder;
positioning the add-on part with a fastening portion at the cylinder;
positioning a counter-holder relative to a side of the cylinder remote of the fastening portion;
feeding movement of a tool carrying a rivet;
piercing the fastening portion with the rivet; and
forming an undercut of a rivet shaft in the counter-holder.

The simple flow of the method facilitates automation.

### BRIEF DESCRIPTION OF THE DRAWINGS

The invention will be described more fully with reference to the following description of the drawings. The drawings show:

FIG. 1 is a piston-cylinder unit with add-on parts;

FIG. 2 is a sectional view through a positive engagement connection;

FIG. 3 is a device for producing the piston-cylinder unit; and

FIGS. 4 and 5 are an alternative counter-holder for a device according to FIG. 3.

### DETAILED DESCRIPTION OF THE PRESENTLY PREFERRED EMBODIMENTS

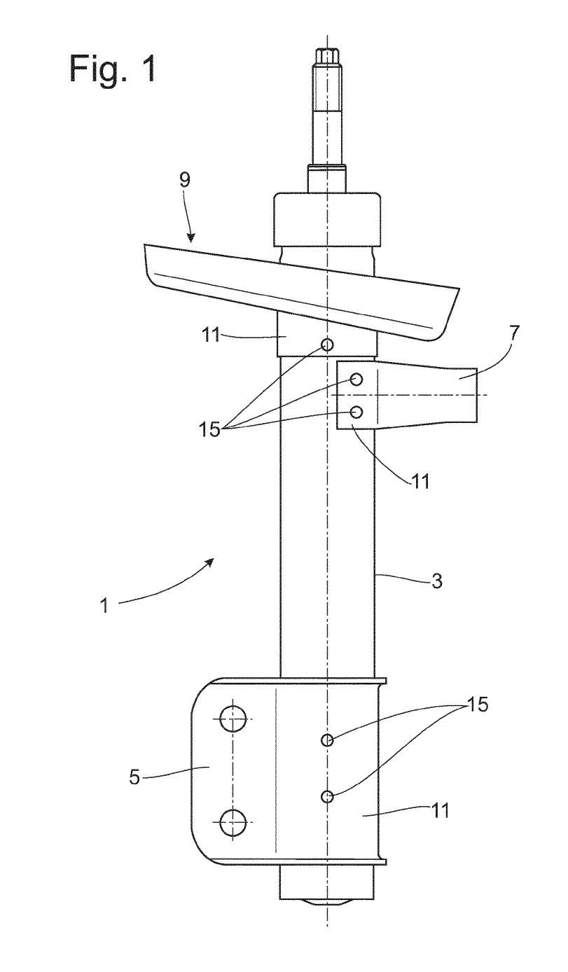

FIG. 1 shows a piston-cylinder unit 1 constructed in the form of a vibration damper. As add-on parts, a bracket 5, a stabilizer holder 7, and a spring plate 9, for example, are fastened to an external, hollow cylinder 3 having a wall that is curved in circumferential direction. Each add-on part has a respective fastening portion 11 adapted to the contact surface of the cylinder 3. In a simple tubular profile, the outer diameter of the cylinder 3 corresponds approximately to the diameter of the fastening portion 11.

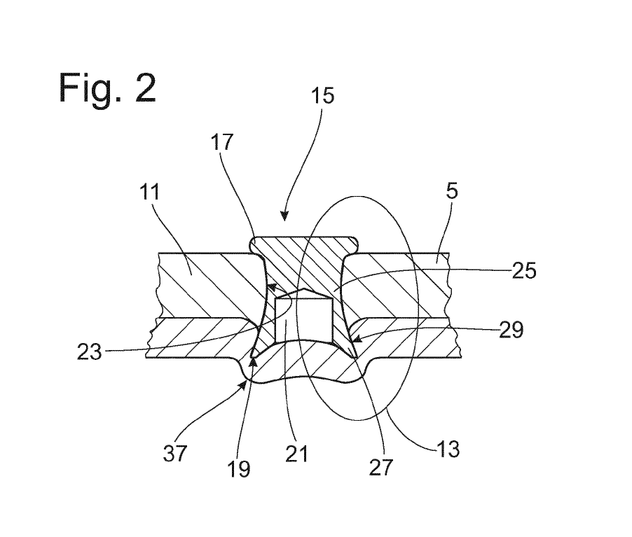

In at least one of the add-on parts 5, 7, and 9, a positive engagement connection 13 is provided between the add-on part and the cylinder 3 according to FIG. 2. A rivet 15 that is separate from the add-on part 5 and cylinder 3 has a rivet head 17 that extends through the fastening portion 11 of the add-on part 5. The rivet head 17 is supported on the fastening portion 11 of the add-on part 5.

The rivet 15 has a cutting end 19 with an inner hollow chamber 21. In the final assembly state of the positive engagement connection 13 shown in the drawing, the end opposite the rivet head 17 has a radial widening that is larger than a clearance cut 23 of a rivet shaft 25 in the add-on part. Accordingly, an undercut 29 having a diameter that substantially corresponds to the diameter of the rivet head 17 is formed between the end 27 of the rivet shaft 25 and the cylinder. The wall of the cylinder 3 is closed so that a medium inside the cylinder cannot exit in the region of the positive engagement connection 13.

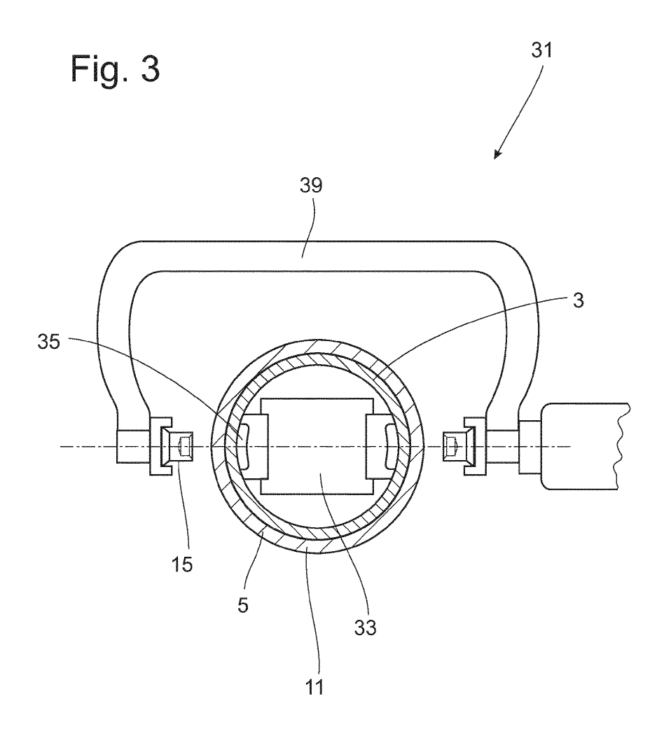

FIG. 3 schematically shows a device 31 for a method by which the cylinder 3 is fixed. By way of example, the add-on part 5 with a sleeve-shaped fastening portion 11 fitted to the outer lateral surface of the cylinder 3 is shown in section. A counter-holder 33 having an axial groove 35 with a profile of a shaping region 37 of the cylinder (FIG. 2) is arranged in the interior of the cylinder 3 in the region of the add-on part 5. The cylinder 3 is axially displaceable owing to the open groove profile 35 in the counter-holder relative to the counter-holder 33 for inserting into and removing from the device 31.

In this embodiment example, a tool that carries two rivets 15 can execute a feeding movement in the opposite direction is used. When the cylinder 3 with the add-on part 5 is placed in the device 31, the rivets 15 are pressed in direction of the cylinder 3. The rivets 15 respectively cut the clearance cut 23 into the fastening portion 11, and the undercut 29 of the rivet shaft 25 is formed in the counter-holder. Due to the feeding movement in the opposite direction and, accordingly, the application of force to the counter-holder, ideally the forces on the counter-holder are compensated such that the counter-holder can be carried out in a comparatively delicate manner. Part of the volume of the cylinder 3 displaced by the rivet shaft 25 is received by the hollow chamber 21 in the rivet shaft 25. Accordingly, the annular end 27 of the rivet shaft 25 is covered at the inner diameter and at the outer diameter such that no free space remains for a radial rebound that could weaken the positive engagement connection 13. In the final assembly state, the rivet head 17 covers the clearance cut 23 through which the rivet shaft 25 extends. To repeat the method process again, the tool 39 is moved back again into its initial position shown in the drawing and the cylinder 3 with its add-on part 5 can be pulled out of the device 31.

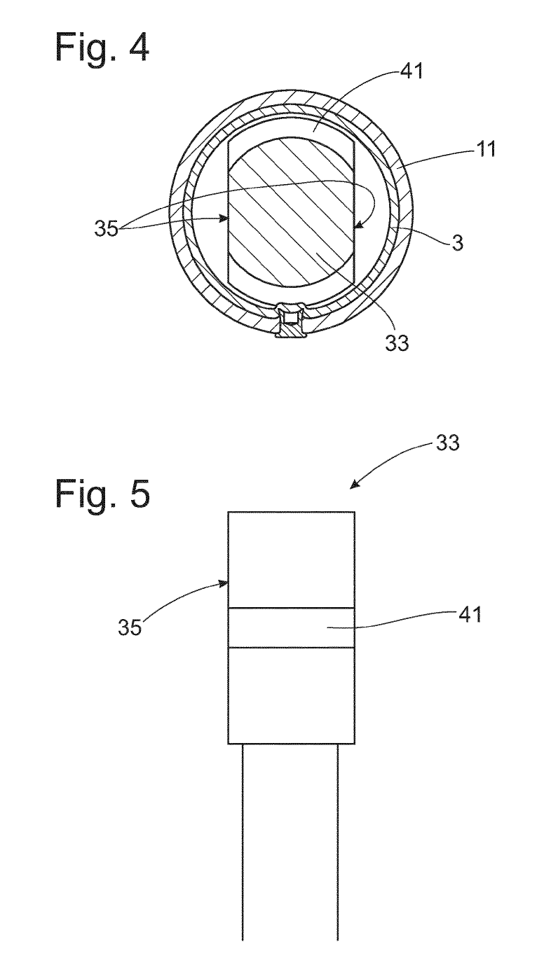

FIGS. 4 and 5 show a counter-holder 33 with two axial grooves 35 and two grooves 41 constructed in circumferential direction. Grooves 35 can be formed, e.g., by simple flattened portions. The principle of operation of the counter-holder 33 according to FIGS. 4 and 5 is identical to that of the tool according to FIG. 3. In contrast, the counter-holder 33 and/or the cylinder 3 carry out, or carries out, a combined rotational and translational working movement inside the device 31 in order to be able to remove the finished combined cylinder 3 and bracket 5 from the device 1. The shaping region 37 of the cylinder is formed by the circumferential groove 41 in longitudinal direction of the counter-holder 33 in an exactly sharp-edged manner. In circumferential direction, a somewhat flowing transition takes place between the shaping region 37 and the inner wall of the cylinder 3. The shaping region which is more sharply stamped in circumferential direction through the groove 41 counteracts a loading of the bracket in longitudinal direction of the cylinder 3 in a particularly effective manner.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A piston-cylinder unit comprising:
a cylinder having a contact surface;
an add-on part having a fastening portion that contacts the contact surface of the cylinder; and
a deformable rivet that extends through the fastening portion in a final assembly position configured to form an undercut with the cylinder creating a positive engagement connection fixing the add-on part to the cylinder.

9. The piston-cylinder unit according to claim 8, wherein the deformable rivet has a rivet head configured to be supported on the fastening portion of the add-on part.

10. The piston-cylinder unit according to claim 9, wherein the deformable rivet has a radial widening at an end opposite the rivet head in the final assembly position.

11. The piston-cylinder unit according to claim 8, wherein the cylinder has a closed wall in a region of the positive engagement connection.

12. The piston-cylinder unit according to claim 8, wherein a rivet shaft extends through a clearance cut in the add-on part.

13. The piston-cylinder unit according to claim 9, wherein the undercut has a diameter that substantially corresponds to a diameter of the rivet head.

14. A method for producing a piston-cylinder unit having a cylinder with an add-on part comprising:
fixing the cylinder;
positioning the add-on part with a fastening portion thereof at the cylinder;
positioning a counter-holder relative to a side of the cylinder remote of the fastening portion;
feeding movement of a tool carrying a rivet;
piercing the fastening portion with the rivet; and
forming an undercut of the cylinder in the counter-holder.
